(19) United States
(12) Patent Application Publication
(10) Pub. No.: US 2025/0363477 A1
(43) Pub. Date: Nov. 27, 2025

(54) SYSTEMS AND METHODS FOR MOBILE DEVICE PAYMENT USING TAP

(71) Applicant: JPMORGAN CHASE BANK, N.A., New York, NY (US)

(72) Inventors: Gerardo GEAN, Plano, TX (US); Raghu VUDATHU, Downingtown, PA (US); Goran LONCARIC, Frisco, TX (US); Maurice SHORROSH, Edgewater, NJ (US); Sandeep Reedy BANALA, Monroe, NJ (US)

(21) Appl. No.: 19/219,651

(22) Filed: May 27, 2025

Related U.S. Application Data
(60) Provisional application No. 63/651,757, filed on May 24, 2024.

(51) Int. Cl. G06Q 20/32; G06Q 20/42

(52) U.S. Cl. CPC G06Q 20/326; G06Q 20/3276; G06Q 20/3278; G06Q 20/42

(57) ABSTRACT

Systems and methods for mobile device payment using tap are disclosed. In one embodiment, a method may include: reading, by a mobile application executed by a mobile electronic device, a machine-readable code comprising an embedded link to a provider website at a uniform resource locator (URL) provided by a provider of a good or service for a transaction involving the good or service; accessing, by the mobile application, the URL; receiving, by the mobile application and from the provider website, a payment by tap option; wirelessly receiving, by the mobile application, payment information from a physical financial instrument; providing, by the mobile application, the payment information to the provider website; and receiving, by the mobile application and from the provider website, confirmation of payment for the transaction.

### RELATED APPLICATIONS

This application claims priority to, and the benefit of, U.S. Provisional Patent Application Ser. No. 63/651,757, filed May 24, 2024, the disclosure of which is hereby incorporated, by reference, in its entirety.

### BACKGROUND OF THE INVENTION

### 1. Field of the Invention

Embodiments relate to systems and methods for mobile device payment using tap.

### 2. Description of the Related Art

As fraud tactics advance, it is important for financial institutions to adopt authentication credentials that blend robust security with user-friendly methods, lessening reliance on one-time passcodes and similar.

### SUMMARY OF THE INVENTION

Systems and methods for mobile device payment using tap are disclosed. In one embodiment, a method may include: reading, by a mobile application executed by a mobile electronic device, a machine-readable code comprising an embedded link to a provider website at a uniform resource locator (URL) provided by a provider of a good or service for a transaction involving the good or service; accessing, by the mobile application, the URL; receiving, by the mobile application and from the provider website, a payment by tap option; wirelessly receiving, by the mobile application, payment information from a physical financial instrument; providing, by the mobile application, the payment information to the provider website; and receiving, by the mobile application and from the provider website, confirmation of payment for the transaction.

In one embodiment, the machine-readable code may include a quick response code.

In one embodiment, the machine-readable code may be provided on a paper invoice.

In one embodiment, the machine-readable code may be dynamic and specific to the transaction.

In one embodiment, the machine-readable code may be static and associated with a location.

In one embodiment, the mobile application wireless reads the payment information by near field communication.

In one embodiment, the machine-readable code may also include an identifier for a provider network; and in response to reading the machine-readable code, the mobile electronic device connects to the provider network.

According to another embodiment, a system may include: a mobile electronic device executing a mobile application; and an electronic device hosting a provider website for a provider at a uniform resource locator (URL). The provider may be configured to generate a machine-readable code for a transaction involving a good or service provided by the provider, the machine-readable code comprising an embedded link to the URL; the mobile application may be configured to read the machine-readable code; the mobile application may be configured to access the URL; the mobile application may be configured to receive, from the provider website, a payment by tap option; the mobile application may be configured to wirelessly receive payment information from a physical financial instrument; the mobile application may be configured to provide the payment information to the provider website; the provider may be configured to execute payment for the transaction using the payment information; and the mobile application may be configured to receive, from the provider website, confirmation of payment for the transaction.

In one embodiment, the machine-readable code may include a quick response code.

In one embodiment, the machine-readable code may be provided on a paper invoice.

In one embodiment, the machine-readable code may be dynamic and specific to the transaction.

In one embodiment, the machine-readable code may be static and associated with a location.

In one embodiment, the mobile application wireless reads the payment information by near field communication.

In one embodiment, the machine-readable code may also include an identifier for a provider network; and in response to reading the machine-readable code, the mobile electronic device may be configured to connect to the provider network.

According to another embodiment, a non-transitory computer readable storage medium may include instructions stored thereon, which when read and executed by one or more computer processors, cause the one or more computer processors to perform steps comprising: reading a machine-readable code comprising an embedded link to a provider website at a uniform resource locator (URL) provided by a provider of a good or service for a transaction involving the good or service; accessing the URL; receiving, from the provider website, a payment by tap option; wirelessly receiving payment information from a physical financial instrument; providing the payment information to the provider website; and receiving, from the provider website, confirmation of payment for the transaction.

In one embodiment, the machine-readable code may include a quick response code.

In one embodiment, the machine-readable code may be dynamic and specific to the transaction.

In one embodiment, the machine-readable code may be static and associated with a location.

In one embodiment, the payment information may be wirelessly read by near field communication.

In one embodiment, the machine-readable code may also include an identifier for a provider network, and further including instructions stored thereon, which when read and executed by the one or more computer processors, cause the one or more computer processors to perform steps comprising: in response to reading the machine-readable code, connecting to the provider network.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for mobile device payment using tap according to an embodiment;

FIG. 2 illustrates a method for mobile device payment using tap according to an embodiment;

FIG. 3 depicts an exemplary computing system for implementing aspects of the present disclosure.

### DETAILED DESCRIPTION OF PREFERRED EMBODIMENTS

Embodiments relate to systems and methods for mobile device payment using tap.

Embodiments not only combat fraud but also streamline the verification process for customers, ensuring a swift, secure, and intuitive experience.

In embodiments, a cardholder may interface with a merchant's network by, for example, joining a Wi-Fi network, and may conduct a transaction using the cardholder's mobile electronic device. In one embodiment, the cardholder may be provided with transaction details and network information by scanning a machine-readable code (e.g., a QR code), by finding a transaction on the merchant's website, etc.

For example, a cardholder may receive a bill from a restaurant with a QR code that includes transaction information, network information, or a uniform resource locator (URL). The cardholder may scan the QR code, which may redirect the cardholder to the merchant's network, the merchant's website at the URL, etc. The cardholder may then present, or tap, a physical payment instrument, such as a credit card, to the cardholder's mobile electronic device, and payment information may be provided to the merchant.

In another embodiment, the customer may enter an identifier for a table, a booth, a service provider (e.g., waiter or waitress), etc., and the merchant may retrieve the invoice using the identifier.

In another embodiment, the customer may provide the service provider with the customer phone number, or an application on the customer's electronic device may present a code, such as a QR code. The merchant may associate the invoice with the phone number, an identifier in the QR code, etc. The customer may then retrieve the invoice, or the invoice may be pushed to the customer's mobile electronic device.

Any suitable identifier may be used as is necessary and/or desired.

As another example, the cardholder may present a physical payment instrument as part of a vehicle rental process. The customer may pair the cardholder's mobile electronic device with a vehicle system, or may access a rental service website, and may present or tap a physical payment instrument to the cardholder's mobile electronic device to authorize payment. The issuing financial institution may also provide the rental service with confirmation that the cardholder is of sufficient age to rent a vehicle. The issuing financial institution may also provide the rental service with rental preferences (e.g., rewards membership information, insurance preferences, etc.), as well as any other information as is necessary and/or desired.

In one embodiment, other physical devices, such as NFC-enabled identification cards, such as driver's licenses, may be presented as well. The cardholder may register these other physical devices with the issuing financial institution.

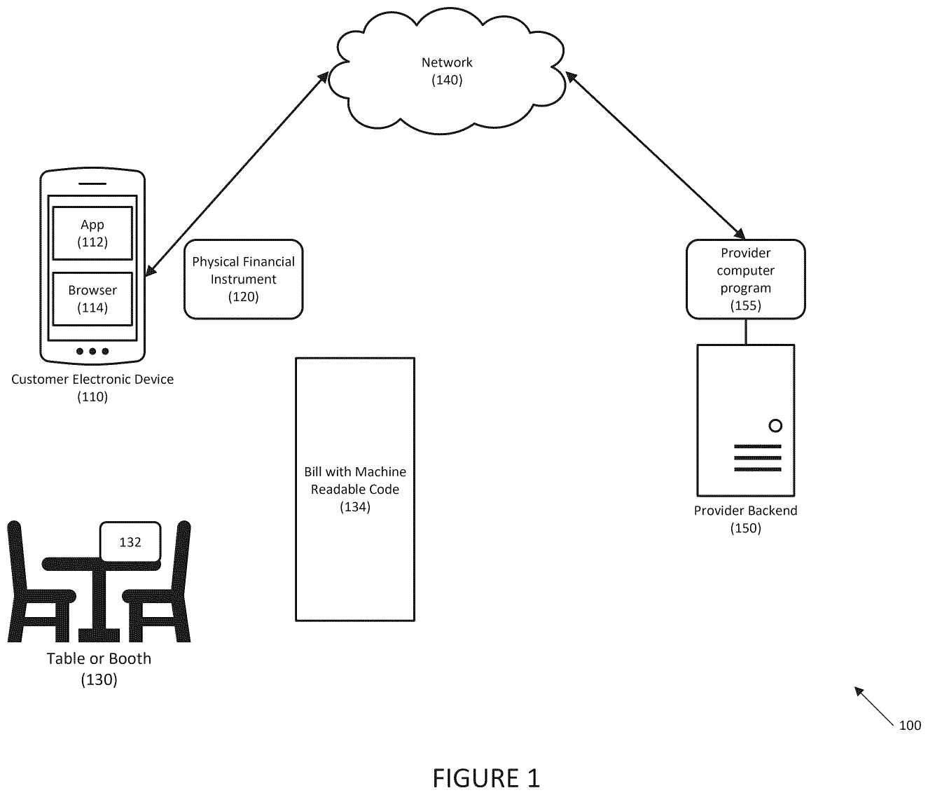

Referring to FIG. 1, a system for mobile device payment using tap is disclosed according to an embodiment. It should be noted that although FIG. 1 depicts a restaurant environment, this environment is not limiting, and other environments (e.g., car rentals, hospitals, etc.) may be applicable as well.

System 100 may include customer electronic device 110, such as a computer, a smart phone, a smart watch, an Internet of Things (IoT) appliance, etc. In one embodiment, customer electronic device 110 may be a mobile electronic device.

In one embodiment, customer electronic device 110 may be a near-field communication (NFC) enabled device, and may wirelessly read information from physical payment instrument 120, such as a credit card.

Customer electronic device 110 may execute one or more computer programs, including application 112 or browser 114. Application 112 may be associated with a provider of a good or service to the customer (e.g., a restaurant, a vehicle rental company, a hospital, etc.).

In one embodiment, the provider may provide network 140, that customer electronic device 110 may connect to. In one embodiment, network 140 may be a private or limited access Wi-Fi network provided by the provider. The use of a network 140 provided by the provider may provide increased security.

In other embodiments, network 140 may be a cellular network or a network that is unaffiliated with the provider.

System 100 may include a good or services location, such as table or booth 130 with machine readable code 132. Instead of a table or booth, the good or service location may include a rental vehicle (e.g., car, boat, bicycle, scooter, etc.).

System 100 may include provider backend 150, which may be a server (e.g., physical and/or cloud-based), a computer (e.g., workstation, desktop, laptop, notebook, tablet, etc.), IoT appliance, etc. Provider backend 150 may execute provider computer program 155, which may provide a payment interface to application 112 or browser 114 via network 140.

Provider computer program 155 may interface with the provider's payment processor (not shown) to process a payment.

In one embodiment, a customer may receive bill 134 with a machine readable code.

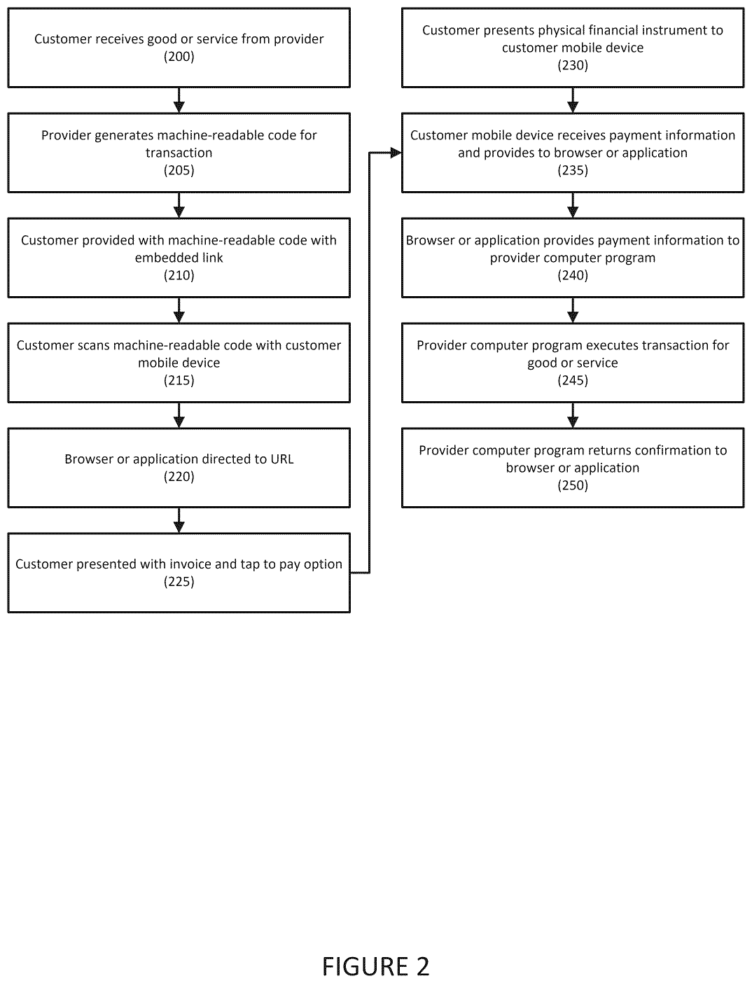

Referring to FIG. 2, a method for mobile device payment using tap is disclosed according to an embodiment.

In step 200, a customer may receive a good or service from a provider of a good or service. Examples of suitable goods or services may include, for example, a meal, a vehicle rental, etc.

In step 205, the provider of the good or service may generate a machine-readable code for a transaction for the good or service. The machine-readable code may include an embedded link to a URL that points to a provider website.

The machine-readable code may be a quick response (QR) code, bar code, etc.

In one embodiment, the machine-readable code may be dynamic and specific to the transaction involving the good or service; in another embodiment, the machine-readable code may be static and may be associated with the location where the good or service is provided or received (e.g., a table at a restaurant, a vehicle, etc.).

In step 210, the customer may be provided with the machine-readable code. For example, the machine-readable code may be included on an invoice (e.g., a meal bill), a rental or purchase agreement, etc., or it may be provided at the location where the good or service is received or provided (e.g., on a table or kiosk at a restaurant).

In step 215, the customer may scan the machine-readable code with the customer's electronic device.

In step 220, scanning the machine-readable code may open an application or browser on the customer's mobile device, and the application or browser may be directed to the provider website at the URL in the machine-readable code.

In one embodiment, the machine-readable code may cause the customer's mobile device to connect to a network, such as the provider's Wi-Fi network.

In step 225, the application or browser may present the customer with an invoice and an option to pay for the invoice using a tap.

In step 230, the customer may present a physical financial instrument to the customer electronic device, and, in step 235, the customer electronic device may read payment information from the physical financial instrument using, for example, NFC. The payment information may be provided to the application or browser.

In step 240, the browser or application may provide the payment information to the provider website or computer program. Once the payment information is received, in step 245, the provider computer program may execute a transaction for the good or service using the payment information.

Once the transaction is complete, in step 250, the provider computer program or computer program may return confirmation to the browser or application.

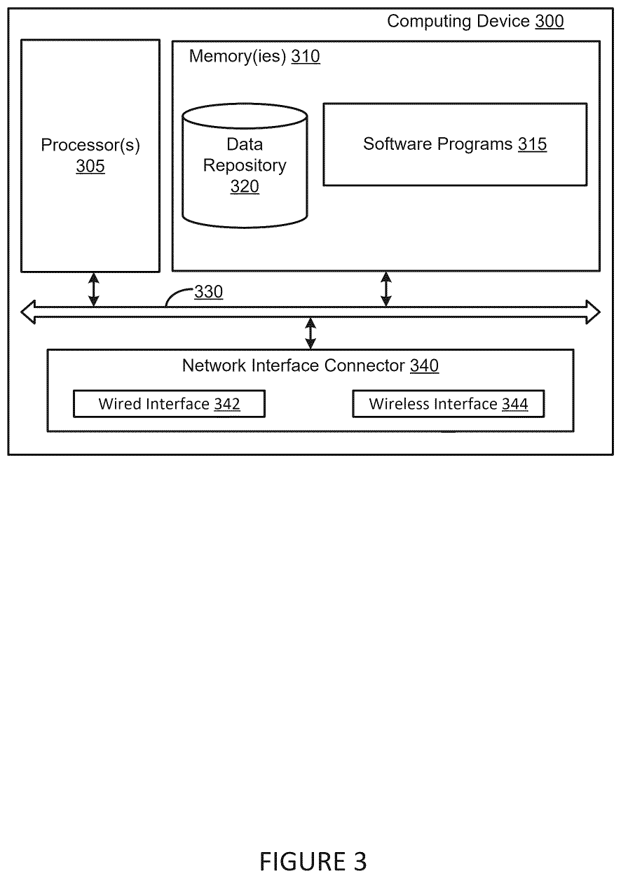

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
reading, by a mobile application executed by a mobile electronic device, a machine-readable code comprising an embedded link to a provider website at a uniform resource locator (URL) provided by a provider of a good or service for a transaction involving the good or service;
accessing, by the mobile application, the URL;
receiving, by the mobile application and from the provider website, a payment by tap option;
wirelessly receiving, by the mobile application, payment information from a physical financial instrument;
providing, by the mobile application, the payment information to the provider website; and
receiving, by the mobile application and from the provider website, confirmation of payment for the transaction.

2. The method of claim 1, wherein the machine-readable code comprises a quick response code.

3. The method of claim 1, wherein the machine-readable code is provided on a paper invoice.

4. The method of claim 1, wherein the machine-readable code is dynamic and specific to the transaction.

5. The method of claim 1, wherein the machine-readable code is static and associated with a location.

6. The method of claim 1, wherein the mobile application wireless reads the payment information by near field communication.

7. The method of claim 1, wherein the machine-readable code further comprises an identifier for a provider network; and
in response to reading the machine-readable code, the mobile electronic device connects to the provider network.

8. A system, comprising:
a mobile electronic device executing a mobile application; and
an electronic device hosting a provider website for a provider at a uniform resource locator (URL);
wherein:
the provider is configured to generate a machine-readable code for a transaction involving a good or service provided by the provider, the machine-readable code comprising an embedded link to the URL;
the mobile application is configured to read the machine-readable code;
the mobile application is configured to access the URL;
the mobile application is configured to receive, from the provider website, a payment by tap option;
the mobile application is configured to wirelessly receive payment information from a physical financial instrument;
the mobile application is configured to provide the payment information to the provider website;
the provider is configured to execute payment for the transaction using the payment information; and
the mobile application is configured to receive, from the provider website, confirmation of payment for the transaction.

9. The system of claim 8, wherein the machine-readable code comprises a quick response code.

10. The system of claim 8, wherein the machine-readable code is provided on a paper invoice.

11. The system of claim 8, wherein the machine-readable code is dynamic and specific to the transaction.

12. The system of claim 8, wherein the machine-readable code is static and associated with a location.

13. The system of claim 8, wherein the mobile application wireless reads the payment information by near field communication.

14. The system of claim 8, wherein the machine-readable code further comprises an identifier for a provider network; and
in response to reading the machine-readable code, the mobile electronic device is configured to connect to the provider network.

15. A non-transitory computer readable storage medium, including instructions stored thereon, which when read and executed by one or more computer processors, cause the one or more computer processors to perform steps comprising:
reading a machine-readable code comprising an embedded link to a provider website at a uniform resource locator (URL) provided by a provider of a good or service for a transaction involving the good or service;
accessing the URL;
receiving, from the provider website, a payment by tap option;
wirelessly receiving payment information from a physical financial instrument;
providing the payment information to the provider website; and
receiving, from the provider website, confirmation of payment for the transaction.

16. The non-transitory computer readable storage medium of claim 15, wherein the machine-readable code comprises a quick response code.

17. The non-transitory computer readable storage medium of claim 15, wherein the machine-readable code is dynamic and specific to the transaction.

18. The non-transitory computer readable storage medium of claim 15, wherein the machine-readable code is static and associated with a location.

19. The non-transitory computer readable storage medium of claim 15, wherein the payment information is wirelessly read by near field communication.

20. The non-transitory computer readable storage medium of claim 15, wherein the machine-readable code further comprises an identifier for a provider network, and further including instructions stored thereon, which when read and executed by the one or more computer processors, cause the one or more computer processors to perform steps comprising:
in response to reading the machine-readable code, connecting to the provider network.
